(19) United States
(12) Patent Application Publication
(10) Pub. No.: US 2016/0048269 A1
(43) Pub. Date: Feb. 18, 2016

(54) Systems, Methods, And Computer Products For Monitoring A Service

(71) Applicants: Peter Vanderyt, Atlanta, GA (US); Seth Michael King, Atlanta, GA (US)

(72) Inventors: Peter Vanderyt, Atlanta, GA (US); Seth Michael King, Atlanta, GA (US)

(21) Appl. No.: 14/485,428

(22) Filed: Sep. 12, 2014

Related U.S. Application Data
(60) Provisional application No. 62/036,333, filed on Aug. 12, 2014.

(51) Int. Cl. G06F 3/0481; G06F 3/0484

(52) U.S. Cl. CPC G06F 3/0481; G06F 3/0484

(57) ABSTRACT

Technologies are described herein for monitoring a service using interaction zones. In some implementations, a service may be associated with one or more interaction zones. The entrance into or removal of items or individuals from the one or more interaction zones may be recorded as a process within the service. The status of the service may be updated by the use of the processes within the service. In further implementations, one or more tools (or items) used for one or more processes of the service may be identified. The status of the service may be updated based on the change in location of the one or more tools with respect to the one or more interaction zones. In still further implementations, one or more individuals that perform various aspects of a process of the service may be identified. The ingress and egress of the one or more individuals with respect to the one or more interaction zones may be used to update the status of the service.

### CROSS-REFERENCE TO RELATED APPLICATION

This application claims priority to U.S. Provisional Patent Application No. 62/036,333 entitled “Systems, Methods, and Computer Products for Monitoring a Service,” filed Aug. 12, 2014, which is incorporated herein by reference in its entirety.

### BACKGROUND

Different steps or processes in a service may be monitored using various technologies. For example, some technologies may use a “check-in” feature. In these technologies, a user or other participant in the service may enter information that shows that a process within a service has occurred. A specific example may be a package delivery service. The person delivering a package may input the location of a package using a bar code system, the location input updating the location of the package. The input may continue to when a recipient of the package signs a device that records the delivery service as being complete upon acceptance of the package.

In another example, some technologies may use a general status update feature. Instead of the location of an item within a service being tracked, one or more users may simply enter a status update to indicate the status of a service. A specific example may be online pizza ordering. A pizza technician may enter a status update of the preparing of the pizza in a computing system, indicating to a customer the status of the overall service.

It is with respect to these and other considerations that the disclosure made herein is presented.

### SUMMARY

Technologies are described herein for monitoring a service using interaction zones. In some implementations, a service (or transaction) may be associated with one or more interaction zones. The entrance into or removal of items or individuals from the one or more interaction zones may be recorded as a process within the service. The status of the service may be updated by the use of the processes within the service. In further implementations, one or more tools (or items or materials) used for one or more processes of the service may be identified. The status of the service may be updated based on the change in location of the one or more tools with respect to the one or more interaction zones. In still further implementations, one or more individuals that perform various aspects of a process of the service may be identified. The ingress and egress of the one or more individuals with respect to the one or more interaction zones may be used to update the status of the service.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of technologies in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a system diagram illustrating an illustrative operating environment for the various technologies disclosed herein.

FIG. 2 is an illustration showing multiple interaction zones.

FIG. 3 is a flow diagram showing aspects of one method disclosed herein for monitoring a service using interaction zones.

FIG. 4 is a flow diagram showing aspects of an alternate method disclosed herein for monitoring a service using interaction zones

FIG. 5 is a computer architecture diagram illustrating an illustrative computer hardware and software architecture for a computing system capable of implementing the technologies presented herein.

FIG. 6 is a computer architecture diagram illustrating a computing device architecture capable of implementing aspects of the various technologies presented herein.

### DETAILED DESCRIPTION

The following detailed description is directed to technologies are described herein for monitoring a service using interaction zones. In some implementations, a service may be associated with one or more interaction zones. The entrance into or removal of items or individuals from the one or more interaction zones may be recorded as a process within the service. The status of the service may be updated by the use of the processes within the service.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and in which are shown, by way of illustration, specific configurations or examples. Referring now to the drawings, in which like numerals represent like elements throughout the several figures, aspects of technologies for monitoring a service using interaction zones will be presented.

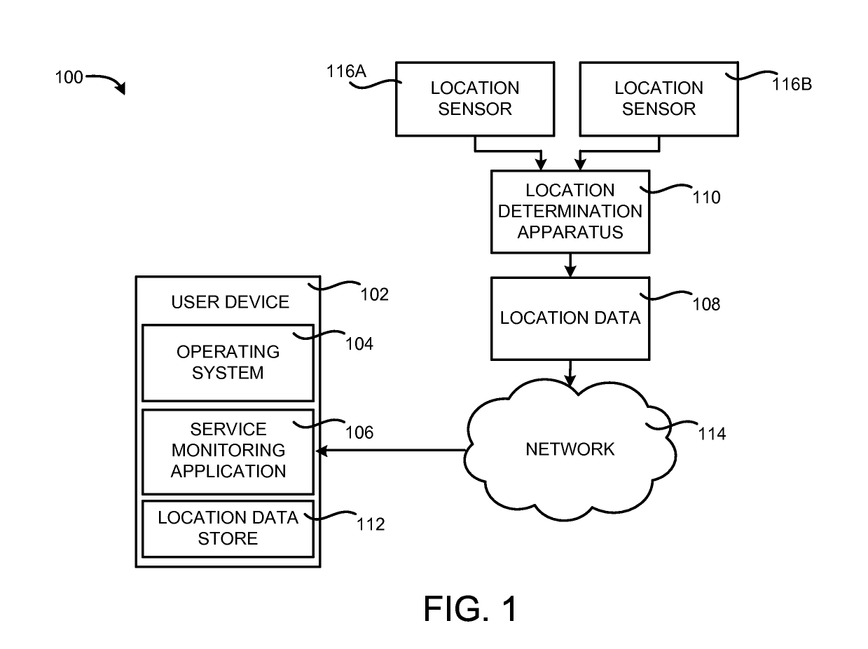

Referring now to FIG. 1, aspects of one operating environment 100 for the various technologies presented herein will be described. The operating environment 100 shown in FIG. 1 includes a user device 102. According to various configurations, the functionality of the user device 102 can be provided by a personal computer (“PC”) such as a desktop, tablet, or laptop computer system. In some other examples, the functionality of the user device 102 can be provided by other types of computing systems including, but not limited to, a handheld computer, a netbook computer, an embedded computer system, a mobile telephone, a smart phone, or another type of computing device.

Various configurations for the user device 102 are illustrated and described below. Although the configurations described herein are described primarily in the context of a user device 102 that is a tablet or slate computing device, a smartphone, or a personal computer, because the functionality described herein with respect to the user device 102 can be provided by additional and/or alternative devices, it should be understood that these configurations are illustrative, and should not be construed as being limiting in any way.

The user device 102 can be configured to execute an operating system 104 and a service monitoring application 106. The operating system 104 is a computer program for controlling the operation of the user device 102. The service monitoring application 106 is an executable program configured to execute on top of the operating system 104. The service monitoring application 106 can provide various types of functions. According to various configurations, for instance, the service monitoring application 106 may be a program configured to receive various inputs and update a status of a service based on the inputs.

In some configurations, the inputs may include, but are not limited to, an input of one or more interaction zones associated with a service, one or more processes associated with the one or more interaction zones, an association of one or more processes with at least one of the one or more interaction zones, an identity of a tool to be used in at least one of the one or more processes, an identity of a service provider to be used in at least one of the one or more processes. The service monitoring application 106 may be configured to update a process of the service based on a location of the tool or the service provider within the one or more interaction zones.

The service monitoring application 106 can be configured to receive location data 108 from a location determination apparatus 110. The service monitoring application 106 may be configured to generate one or more updates to a process of a service or to change the identity of a tool or service provider based on the location data 108. The user device 102 may be configured to store the location data 108 within a location data store 112. The location data 108 may be received from the location determination apparatus 110 in various ways. In the example illustrated in FIG. 1, the location data 108 is received through a network 114. The network 114 may be comprises of various types of networks, the subject matter disclosed herein not being limited to any particular manner in which the location data 108 is received by the service monitoring application.

The location data 108 may be generated from location information provided by location sensors 116A and 116B. The location sensors 116A and 116B may be one or more modules configured to provide location information to the location determination apparatus 110. In some examples, the location determination apparatus 110 may comprise an infrared light system. The location sensors 116A and 116B may comprise an infrared light transmitter, an infrared light receiver, and a computing apparatus configured to determine a location based on infrared light transmitted by the infrared light transmitter and received at the infrared light receiver.

In other examples, the location determination apparatus 110 may comprise a global position system whereby the location sensors 116A and 116B may be global positioning sensors configured to output a location based on global position system signals. In still further examples, the location determination apparatus 110 may comprise a radio frequency tag system, whereby location information is provided by a radio frequency tags located on one or more tools or service providers.

FIG. 1 illustrates one user device 102, one network 114, and one location determination apparatus 110. It should be understood, however, that some implementations of the operating environment 100 include multiple user devices 102, multiple networks 114, and/or multiple location determination apparatuses 110. The illustrated examples described above and shown in FIG. 1 should be understood as being illustrative, and should not be construed as being limiting in any way.

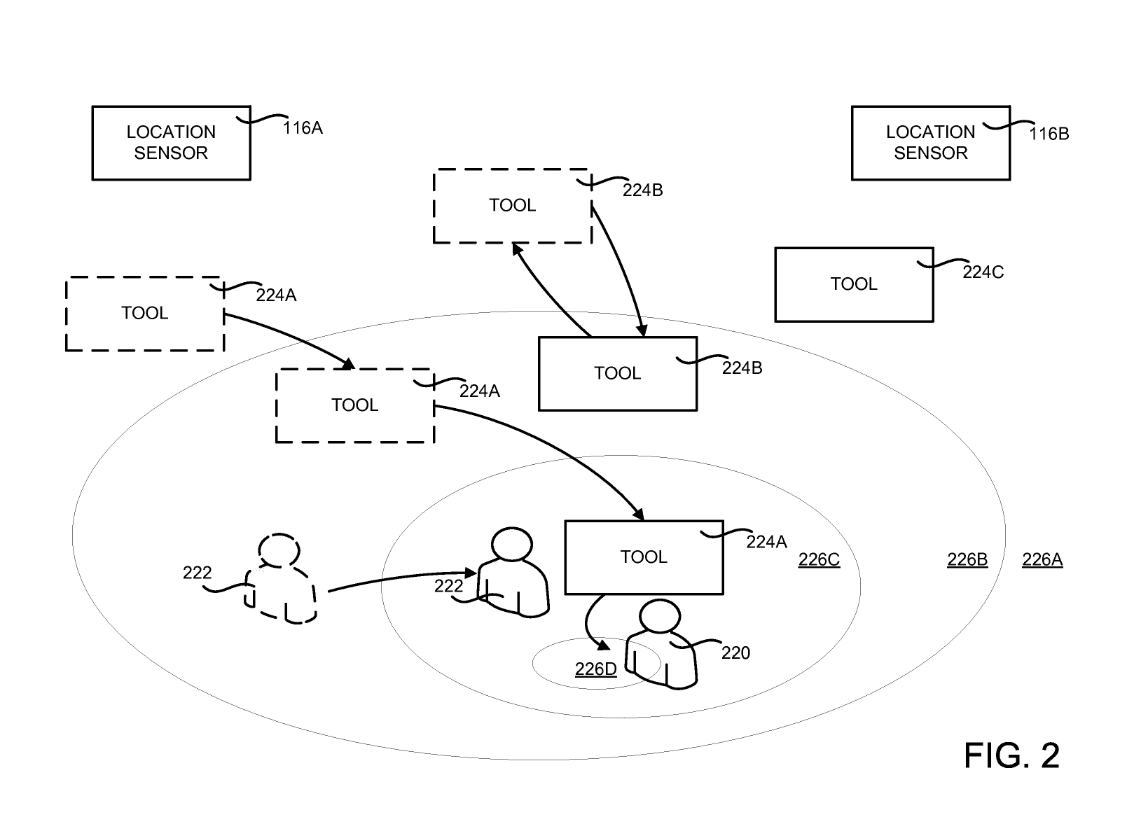

FIG. 2 is illustration showing multiple interaction zones. In FIG. 2, a service receiver 220 is shown. The service receiver 220 may receive a service provided in a service from a service provider 222. The service provider 222 may use one or more tools 224A-224C (hereinafter referred to collectively as “the tools 224”). The tools 224 may be identified in various manners. For example, the tools 224 may be identified by their use within the service.

In one specific example, the tools 224 may be various forms of surgical equipment in a service involving a surgery. In another example, the tools 224 may be identified based on their status in the service. For example, the identity of the tools 224 may be an invalid condition or a valid condition. An invalid condition may occur, by way of example and not by way of limitation, if certain conditions of the service are not met, described in more detail below. The presently disclosed subject matter is not limited to any particular type of tool. For example, a tool may include, but is not limited, to a device, item, material, machine, machinery, substance, or other object used in a service.

Also illustrated in FIG. 2 are interaction zones 226A-226D (hereinafter referred to collectively as “the interaction zones 226”). The interaction zones 226 may be associated with one or more processes or steps within a service. The interaction zones 226 may also be associated with locations associated with the processes or steps within a service. The presently disclosed subject matter is not limited to any particular manner in which the interaction zones 226 are designated.

In some examples, the interaction zones 226 may be geographic locations associated with the service provided to the service receiver 220. For example, the interaction zones 226 may be associated with geographic locations of a surgery center in which the service receiver 220 may receive surgical services from the service provider 222 (which may be a doctor or nurse). In these examples, the interaction zone 226A may geographically cover a hospital, the interaction zone 226B may geographical cover a surgery ward of the hospital, the interaction zone 226C may geographically cover the an operation room, and the interaction zone 226D may geographically cover a location of a patient to be operated on.

In some examples, the interaction zones 226 may be time-sensitive. In one example, the tools 224 within the interaction zone 226A may be valid at one point in time and invalid at another point in time. In another example, the transaction zones 226 may change as a function of time. In one example, the interaction zone 226A may not be an interaction zone at one point in time and may be an interaction zone at another point in time. It should be noted that these and other implementations of time-based interaction zones 226, such as the examples described herein, are considered to be within the scope of the presently disclosed subject matter.

Continuing with the present example, the service monitoring application 106 of FIG. 1 may receive the inputs of the interaction zones 226, the service receiver 220, the service provider 222 and the tools 224. The location sensors 116 may be used to determine the location of the tools 224 and the service provider 222 within the interaction zones 226. The location sensors 116 may be positioned in various locations to allow for location determination. It should be noted that the use of two location sensors 116 is merely illustrative, as various aspects of the presently disclosed subject matter may use one or more than two location sensors 116.

The identity of the tools 224 may be updated based on the location of the tools 224 within the interaction zones 226. For example, the tool 224A when in interaction zone 226A may be identified as in a stored condition. The tool 224B, when in interaction zones 226B or 226B, may be identified as in an in-transport condition. The tool 224A, when in interaction zone 226D, may be considered as an in-use condition. When the tool 224A is moved from the interaction zone 226D to the interaction zone 226C, the tool 224A may be identified in a used condition.

It should be noted that the tools 224 may be identified in fewer conditions than the example illustrated above. For example, the tool 224B may be identified as in a stored condition when in interaction zone 226A and in an in-transport condition when moved from the interaction zone 226A to the interaction zone 226B. But, the identity of the tool 224B may be updated to indicate a stored condition if the tool 224B is moved from the interaction zone 226B back to the interaction zone 226A. The identity of the tool 224C may remain in a stored condition if the tool 224C is not moved from the interaction zone 226A.

A status of the service may be updated based on the location of the tools 224. In some examples, the tools 224 may be used in different processes of the service. As the tools 224 are moved in and out of the interaction zones 226, the changing location of the tools 224 may indicate the performance of a process of the service. For example, the tool 224A may be associated with a final procedure in a surgery. When the tool 224A is moved from the interaction zone 226D to the interaction zone 226C, the changing location proximate to the service receiver 220 may indicate that the status of the service (e.g. a surgery in the present example) has been completed.

The location of the tools 224 proximate to the service receiver 222, the service provider 222, and/or the interaction zones 226 may also be used to determine valid or invalid conditions. In some examples, the tool 224B may be a tool not used in a process of the service. If the tool 224B is moved from the interaction zone 226A to the interaction zone 226B, this may indicate that the tool 224B was improperly moved or improperly used. In these examples, the location change may indicate an invalid condition with respect to the service associated with the interaction zones 226.

In a similar manner, the location of the service provider 222 proximate to the service receiver 222, the service provider 222, and/or the interaction zones 226 may also be used to determine valid or invalid conditions. In some examples, the service provider 222 may be a doctor not cleared to be in the interaction zone 226D. If the location of the service provider 222 is within the interaction zone 226D, an invalid condition may be generated with respect to the service.

In some examples, the interaction zones 226 may be designated to be valid with respect to the service provider 222 in certain processes of the service. In one example, it may be determined that a service provider 222 should not be in the interaction zone 226D during a certain process and should be in the interaction zone 226D during another process of the service. If the service provider 222 is in the interaction zone 226D when the interaction zone 226D is designated invalid, an invalid condition of the process may be generated. In a similar manner, if the service provider 222 is in the interaction zone 226D when the interaction zone 226D is designated as valid, a valid condition of the process may be generated.

In some examples, the interaction zones 226 may be designated to be valid with respect to the tools 224 in certain processes of the service. In one example, it may be determined that the tool 224A should not be in the interaction zone 226D during a certain process and should be in the interaction zone 226D during another process of the service. If the tool 224A is in the interaction zone 226D when the interaction zone 226D is designated invalid, an invalid condition of the process may be generated. In a similar manner, if the tool 224A is in the interaction zone 226D when the interaction zone 226D is designated as valid, a valid condition of the process may be generated.

Various examples of the presently disclosed subject matter may be used for monitoring different types of services. In one example, various aspects of the presently disclosed subject matter may be used in a medical application. For example, a surgeon may wear one or more automatic identification and data capture devices (AIDC devices). Examples of AIDC devices include, but are not limited to: RFID bracelet, RFID scrubs/work clothing, surgical or work gloves with AIDC identifiers. The surgeon may bring a medical instrument into one of the interaction zones 226. The medical instrument may have an RFID strip attached, an IR painted identifier, or any number of unique methods of identifying the tool or item involved, into one of the service interaction zones. A patient may also be wearing a AIDC identifier in the operating room. A system may detect this proximity and record the interaction.

A system may use AIDC and other data collection technologies to interface with computers for the purpose of monitoring crucial aspects of interactions between multiple parties: who, when, where, what was used, and also how was an action performed. Further, a system may use software to prompt attestation as to how moments of the interaction took place. To use an example of a nurse in triage, when the employee administers the medication to the patient, all three unique AIDC identifiers—employee, patient, and medication—may be in close proximity within a service interaction zone.

A system may detect this interaction as proximity can equal a result in interactions, and a prompt or signal may be relayed to one or more computing devices configured to transmit a prompt to the software for the nurse to later attest as to whether he or she was in fact in the room and did in fact administer a specific medication to the patient at a specific time. This general example in no way precludes the use of this system to monitor blood, IV use, or any number of activities of nurses in their respective job descriptions.

An AIDC identifier, such as an RFID bracelet, glove, necklace, band, adhesive, clothing, or the like, may be placed on a patient, on each provider (doctors, nurses, medical assistants, and the like) and on products (scalpel, gauze, medications, and the like) used in the operating room. Multiple AIDC Scanners/Readers may be placed in the operating room for the purpose of scanning and possibly triangulating the specific proximity of the operating table, and the surrounding interaction zones.

Interactions of the three Ps, Patient, Provider, and Product (3PS), within a defined area of the operating table (the defined area may differ by hospital, state, or country) may be captured by AIDC Scanner/Readers. These AIDC scanners/readers may generate data and interface with a system data store or database. For example, the location data 108 may be generated by AIDC scanners/readers. The location data 108 may be transmitted to the location data store 112. Some technologies may use radio frequency (RF)technology to monitor the interaction in the operating room of all Providers (doctors, nurses, medical assistants, and the like), and what Products (scalpel, gauze, medication, and the like) that were used on the Patient.

More specifically, some implementations of a system may provide information relating to which Provider used what Products on a specific Patient, and for how long. This information may be provided to the service monitoring application 106, which may be monitoring one or more services being provided at one time. Through the use of various implementations, various interactions within the operating room may be captured. Various information may be used in various contexts. For example, the location data 108, including time data and tool use data, may be used for billing purposes.

In one example, when a surgery lasts four hours, providers using some convention technologies may report and attest to the services rendered in a manner very similar to the “honor system.” Specifically, four hours after a surgery begins the Providers are given their first chance to attest to the services rendered. The human memory may not be accurate in reassessing four hour procedures. Monitoring the service may increase efficiency.

Various aspects of the presently disclosed subject matter may be used in other industries. For example, the presently disclosed subject matter may be used is in commercial plumbing. Plumbing companies could use an implementation of the presently disclosed subject matter to monitor work sites in real time. Specifically, the presently disclosed subject matter could be used to monitor which Plumbers used what materials and Products at which work site or Problem. All of the plumbers/employees would have on them a unique AIDC identifier such as an RFID, glove, clothing, and the like, and all tools and materials would have unique AIDC identifiers like Infrared Paint, RFIDs, and the like, attached to them.

A plumbing company may install portable AIDC Scanners/Readers on site and would have them on at all times when employees are on site. Portals would be set up through the system software so that both the commercial plumbing company and the customer could access real time information regarding plumbing projects. The customer could see where the project is in terms of progress, and could tell if it is on budget in terms of labor hours and materials used. The commercial plumbing company could use the portal to increase efficiency. The plumbing company could analyze what type of plumbers have worked on the site, for how long, what types of tools and materials were employed, and the company could make recommendations to the project managers.

Finally, parts, tools, and materials to be used on the work site may have RFID tags or strips attached to them. In the case of long tubes of piping, RFID strips could be placed every foot or some other useful measurement so how much material is used could be accurately recorded. The plumbing company could use the system in a manner very similar to the example of the operating room in the hospital above. The plumbers and plumbing company employees and subcontractors could, at the end of each working day, be prompted by the system software if they did for example use a certain amount of material in a specific area. The workers could also be prompted as to how they performed certain tasks as recorded by the interactions. Again, once this data has been attested to by the workers, it can be sent to the customers of the plumbing company or third party payment companies.

3PS databases may record the raw data of the observed interactions. Each interaction can be said to create a node, or chunk of data. This chunk of data contains the information gathered from monitoring an interaction. The data chunks contain the information of who was involved in the interaction, where the interaction took place, for how long, and what parts/products/items that have RFIDs attached to them were used. The data chunks may not record how an interaction transpires, as that may be the responsibility of a 3PS software. The 3PS software may be the go-between for the database and the end user of 3PS. An example of a 3PS software may be the service monitoring application 106 of FIG. 1.

Each chunk of data may be sent from a 3PS database or data store to the end user's software. In one example, the end user may be the hospital. The data may be in the form of customized information or customized requests for information. An example of a customized request for information could be asking the surgeon if he did in fact implant a specific medical device within a patient. This request may require attestation from the surgeon. This attestation from the surgeon may complete the final questions remaining from monitoring the interactions within the operating room. Namely, what exactly transpired when certain elements interacted within the predefined proximity, and how did the Providers involved conduct themselves during the interactions.

Another benefit of some implementations is oversight. From the plumbing example, the plumbing company could start to track patterns such as when a certain grade plumber uses certain materials to fix a problem. The results may not be as efficient as when a different grade plumber uses a different set of materials. From such analysis, gains can be made in terms of efficiency. The same methods could be applied to fraudulent billing, because the amount of time/labor and materials used may be recorded.

Various implementations of the presently disclosed subject matter may be focused on the interactions of multiple persons and things wearing unique identifiers or other locational tracking GPS devices for the purpose of defining these interactions. An example of how the presently disclosed subject matter could be used in a hospitality example would be if a hair stylist wearing, in this example, an RFID bracelet or unique identifying glove, entered the hotel room of the tourist who is also wearing an RFID bracelet or necklace (patent pending) or unique band (patent pending). If the hair stylist used hair styling equipment that in this example is tagged with RFID strips in a determined proximity the tourist, then the RF readers in the hotel room could record each interaction of the two people with each new piece of equipment. Depending on the type of equipment used, the total time spent by the hair stylist, and possibly the experience level of the hair stylist, the hotel could then offer to both the tourist and the hairstylist the opportunity to verify all aspects of said interaction. The system can be adjusted to the specifications of any service industry, and the specifications of each company within each industry.

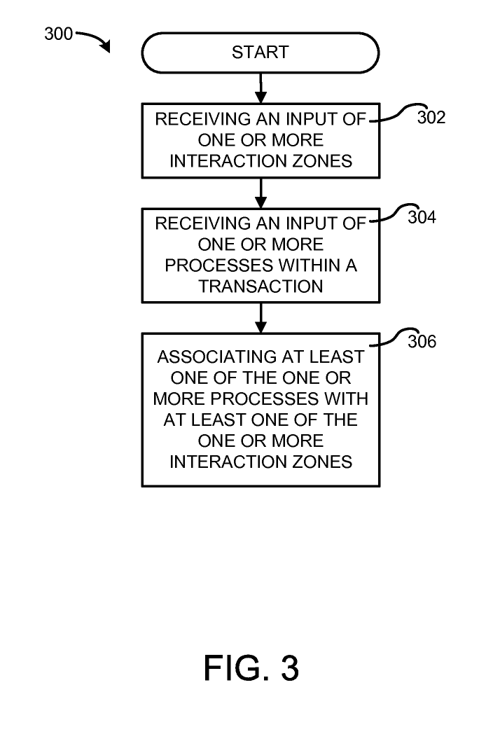

Turning now to FIG. 3, aspects of a method 300 for monitoring a service using interaction zones will be described in detail. It should be understood that the operations of the method 300 are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated method 300 can be ended at any time and need not be performed in its entirety. Some or all operations of the method 300, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein can be implemented as a sequence of computer implemented acts or program modules running on a computing system, and/or as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For purposes of illustrating and describing the concepts of the present disclosure, the method 300 disclosed herein is described as being performed by the user device 102 via execution of computer executable instructions such as, for example, the service monitoring application 106. As explained above, the service monitoring application 106 can include functionality for monitoring a service using interaction zones. As such, while the method 300 is described as being provided by the user device 102, it should be understood that the user device 102 can provide the functionality described herein via execution of various application program modules and/or elements. Additionally, devices other than, or in addition to, the user device 102 can be configured to provide the functionality described herein via execution of computer executable instructions other than those explicitly disclosed herein. As such, it should be understood that the described configuration is illustrative, and should not be construed as being limiting in any way.

The method 300 begins at operation 302 (“receiving an input of one or more interaction zones”), where an input of one or more interaction zones 226 may be input. In some examples, the service monitoring application 106 may be configured to receive the input of one or more interaction zones 226.

The method 300 may continue to operation 304 (“receiving an input of one or more processes within a service”), where an input of one or more processes within a service may be input. In some examples, the service monitoring application 106 may be configured to receive the input of one or more processes.

The method 300 may continue to operation 306 (“associating at least one of the one or more processes with at least one of the one or more interaction zones”), where at least one of the one or more processes may be associated with at least one of the one or more interaction zones. The method 300 may continue or may end at various operations. As such, the method 300 can end or the method 300 can be repeated any number of times.

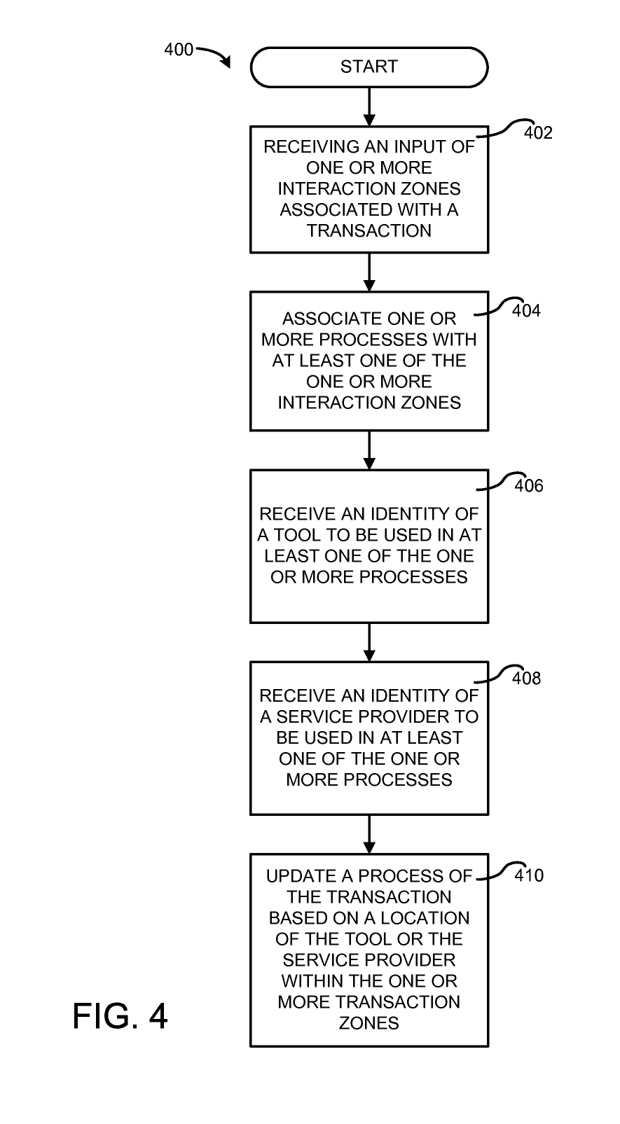

FIG. 4 is an illustration showing aspects of an alternate method 400 for monitoring a service using interaction zones. The method 400 may commence at operation 402 (“receive an input of one or more interaction zones associated with a service, the service comprising one or more processes”), where an input is received of one or more interaction zones associated with a service, the service comprising one or more processes.

The method 400 may continue to operation 404 (“associate one or more processes with at least one of the one or more interaction zones”), where one or more processes are associated with at least one of the one or more interaction zones.

The method 400 may continue to operation 406 (“receive an identity of a tool to be used in at least one of the one or more processes”), where an identity of a tool to be used in at least one of the one or more processes is received.

The method 400 may continue to operation 408 (“receive an identity of a service provider to be used in at least one of the one or more processes”), where an identity of a service provider to be used in at least one of the one or more processes is received.

The method 400 may continue to operation 410 (“update a process of the service based on a location of the tool or the service provider within the one or more interaction zones”), where a process of the service based on a location of the tool or the service provider within the one or more interaction zones is updated.

Various aspects of the presently disclosed subject matter may be considered in view of the following clauses:

Clause 1. A computer-implemented method comprising performing computer-implemented operations for:

receiving an input of one or more interaction zones;
receiving an input of one or more processes within a service; and
associating at least one of the one or more processes with at least one of the one or more interaction zones.

Clause 2. The computer-implemented method of clause 1, further comprising receiving an identity of a tool to be used in at least one of the one or more processes.

Clause 3. The computer-implemented method of clauses 1-2, further comprising associating the identity of the tool with at least one of the one or more processes.

Clause 4. The computer-implemented method of clauses 1-3, further comprising updating a status of the service based on a location of the tool with respect to the one or more interaction zones.

Clause 5. The computer-implemented method of clauses 1-4, where the status of the service comprises a valid condition or an invalid condition.

Clause 6. The computer-implemented method of clauses 1-5, further comprising receiving an identity of a service provider to be used in at least one of the one or more processes.

Clause 7. The computer-implemented method of clauses 1-6, further comprising associating the identity of the service provider with at least one of the one or more processes.

Clause 8. The computer-implemented method of clauses 1-7, further comprising updating a status of the service based on a location of the service provider with respect to the one or more interaction zones.

Clause 9. The computer-implemented method of clauses 1-8, where the status of the service comprises a valid condition or an invalid service provider.

Clause 10. A computer-readable storage medium having computer readable instructions stored thereupon that, when executed by a computer, cause the computer to:
receive an input of one or more interaction zones associated with a service, the service comprising one or more processes;
associate one or more processes with at least one of the one or more interaction zones;
receive an identity of a tool to be used in at least one of the one or more processes;
receive an identity of a service provider to be used in at least one of the one or more processes; and
update a process of the service based on a location of the tool or the service provider within the one or more interaction zones.

Clause 11. The computer-readable storage medium of clause 10, wherein a valid condition occurs when the tool is proximate to the service provider when the service provider is within a designated interaction zone of the one or more interaction zones and an invalid condition occurs when the service provider is not within the designated interaction zone of the one or more interaction zones.

Clause 12. The computer-readable storage medium of clauses 10-11, wherein the identity of the tool comprises a stored condition, an in-transport condition, an in-use condition, or a used condition.

Clause 13. The computer-readable storage medium of clauses 10-12, wherein at least one process of the one or more processes comprises an invalid condition if an incorrect tool is located within a designated interaction zone during the at least one process.

Clause 14. The computer-readable storage medium of clauses 10-13, wherein at least one process of the one or more processes comprises an invalid condition if a correct tool and an incorrect service provider are located within a designated interaction zone during the at least one process.

Clause 15. A system comprising:

a location determination apparatus; and
a computing system comprising
a processor; and
a computer-readable storage medium in communication with the processor, the computer-readable storage medium having computer-executable instructions stored thereupon which, when executed by the processor, cause the processor to receive an input of one or more interaction zones associated with a service, the service comprising one or more processes;
associate one or more processes with at least one of the one or more interaction zones;
receive an identity of a tool to be used in at least one of the one or more processes;
receive an identity of a service provider to be used in at least one of the one or more processes; and
update a process of the service based on a location, provided by the location determination apparatus, of the tool or the service provider within the one or more interaction zones.

Clause 16. The system of clause 15, wherein at least one process of the one or more processes comprises an invalid condition if an incorrect tool is located within a designated interaction zone during the at least one process.

Clause 17. The system of clauses 15-16, wherein at least one process of the one or more processes comprises an invalid condition if a correct tool and an incorrect service provider are located within a designated interaction zone during the at least one process.

Clause 18. The system of clauses 15-17, wherein the location determination apparatus comprises an infrared light transmitter, an infrared light receiver, and a computing apparatus configured to determine a location based on infrared light transmitted by the infrared light transmitter and received at the infrared light receiver.

Clause 19. The system of clauses 15-18, wherein the location determination apparatus comprises a global positioning system.

Clause 20. The system of clauses 15-19, wherein the location determination apparatus comprises a radio frequency tag system.

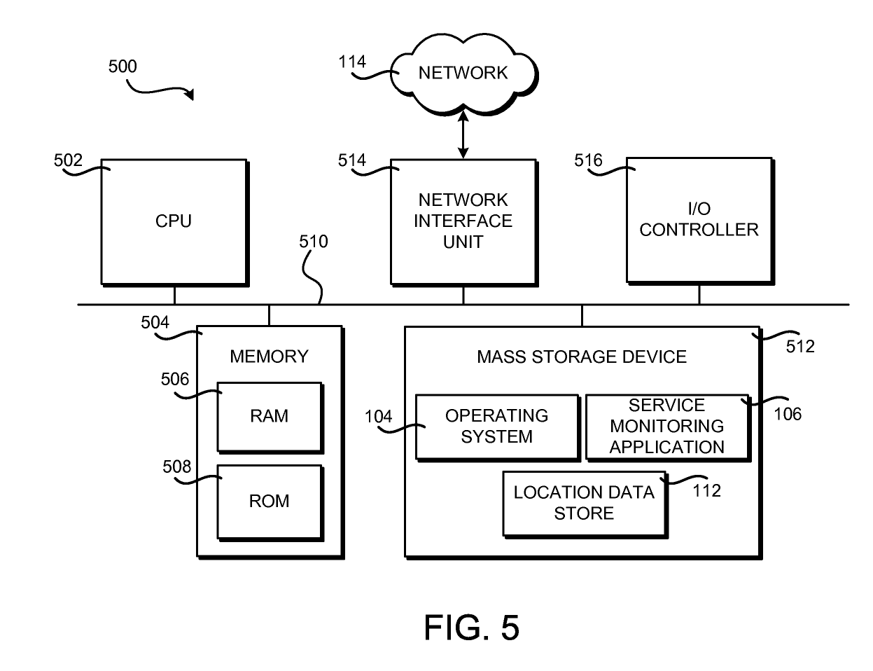

FIG. 5 illustrates an illustrative computer architecture 500 for a device capable of executing the software components described herein for monitoring a service using interaction zones. Thus, the computer architecture 500 illustrated in FIG. 5 illustrates an architecture for a server computer, mobile phone, a PDA, a smart phone, a desktop computer, a netbook computer, a tablet computer, and/or a laptop computer. The computer architecture 500 may be utilized to execute any aspects of the software components presented herein. For example, the computer architecture 500 might be utilized to implement the user device 102 described above with regard to FIG. 1.

The computer architecture 500 illustrated in FIG. 5 includes a central processing unit 502 (“CPU”), a system memory 504, including a random access memory 506 (“RAM”) and a read-only memory (“ROM”) 508, and a system bus 510 that couples the memory 504 to the CPU 502. A basic input/output system containing the basic routines that help to transfer information between elements within the computer architecture 500, such as during startup, is stored in the ROM 508. The computer architecture 500 further includes a mass storage device 512 for storing the operating system 104 and one or more application programs including, but not limited to, the service monitoring application 106. The mass storage device 512 also can be configured to store data such as, for example, the location data store 112.

The mass storage device 512 is connected to the CPU 502 through a mass storage controller (not shown) connected to the bus 510. The mass storage device 512 and its associated computer-readable media provide non-volatile storage for the computer architecture 500. Although the description of computer-readable media contained herein refers to a mass storage device, such as a hard disk or CD-ROM drive, it should be appreciated by those skilled in the art that computer-readable media can be any available computer storage media or communication media that can be accessed by the computer architecture 500.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer storage media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 500. For purposes of the claims, a “computer storage medium” or “computer-readable storage medium,” and variations thereof, do not include waves, signals, and/or other transitory and/or intangible communication media, per se. For the purposes of the claims, “computer-readable storage medium,” and variations thereof, may refer to one or more types of articles of manufacture.

According to various examples or configurations, the computer architecture 500 may operate in a networked environment using logical connections to remote computers through a network such as the network 114. The computer architecture 500 may connect to the network 114 through a network interface unit 514 connected to the bus 510. It should be appreciated that the network interface unit 514 also may be utilized to connect to other types of networks and remote computer systems. The computer architecture 500 also may include an input/output controller 516 for receiving and processing input from a number of other devices, including a keyboard, mouse, or electronic stylus (not shown in FIG. 5). Similarly, the input/output controller 516 may provide output to a display screen, a printer, or other type of output device (also not shown in FIG. 5).

It should be appreciated that the software components described herein may, when loaded into the CPU 502 and executed, transform the CPU 502 and the overall computer architecture 500 from a general-purpose computing system into a special-purpose computing system customized to facilitate the functionality presented herein. The CPU 502 may be constructed from any number of transistors or other discrete circuit elements, which may individually or collectively assume any number of states. More specifically, the CPU 502 may operate as a finite-state machine, in response to executable instructions contained within the software modules disclosed herein. These computer-executable instructions may transform the CPU 502 by specifying how the CPU 502 transitions between states, thereby transforming the transistors or other discrete hardware elements constituting the CPU 502.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 500 in order to store and execute the software components presented herein. It also should be appreciated that the computer architecture 500 may include other types of computing devices, including hand-held computers, embedded computer systems, personal digital assistants, and other types of computing devices known to those skilled in the art. It is also contemplated that the computer architecture 500 may not include all of the components shown in FIG. 5, may include other components that are not explicitly shown in FIG. 5, or may utilize an architecture completely different than that shown in FIG. 5.

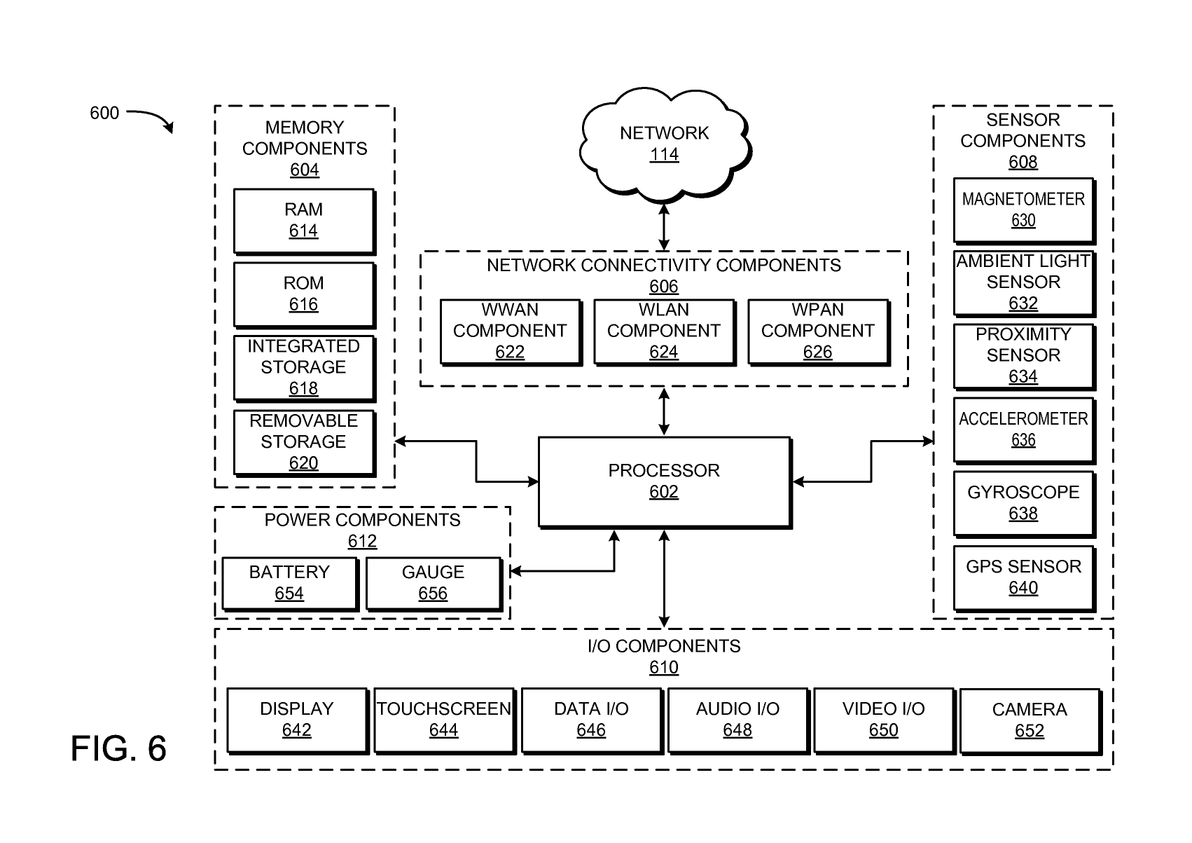

Turning now to FIG. 6, an illustrative computing device architecture 600 for a computing device that is capable of executing various software components described herein for monitoring a service using interaction zones. The computing device architecture 600 is applicable to computing devices that facilitate mobile computing due, in part, to form factor, wireless connectivity, and/or battery-powered operation. In some configurations, the computing devices include, but are not limited to, mobile telephones, tablet devices, slate devices, portable video game devices, and the like.

Aspects of the computing device architecture 600 may be applicable to traditional desktop computers, portable computers (e.g., laptops, notebooks, ultra-portables, and netbooks), server computers, and other computer systems, such as described herein with reference to FIG. 5. For example, the single touch and multi-touch aspects disclosed herein below may be applied to desktop computers that utilize a touchscreen or some other touch-enabled device, such as a touch-enabled track pad or touch-enabled mouse.

The computing device architecture 600 illustrated in FIG. 6 includes a processor 602, memory components 604, network connectivity components 606, sensor components 608, input/output components 610, and power components 612. In the illustrated configuration, the processor 602 is in communication with the memory components 604, the network connectivity components 606, the sensor components 608, the input/output (“I/O”) components 610, and the power components 612. Although no connections are shown between the individuals components illustrated in FIG. 6, the components can interact to carry out device functions. In some configurations, the components are arranged so as to communicate via one or more busses (not shown).

The processor 602 includes a central processing unit (“CPU”) configured to process data, execute computer-executable instructions of one or more application programs, and communicate with other components of the computing device architecture 600 in order to perform various functionality described herein. The processor 602 may be utilized to execute aspects of the software components presented herein and, particularly, those that utilize, at least in part, a touch-enabled input.

In some configurations, the processor 602 includes a graphics processing unit (“GPU”) configured to accelerate operations performed by the CPU, including, but not limited to, operations performed by executing general-purpose scientific and engineering computing applications, as well as graphics-intensive computing applications such as high resolution video (e.g., 720P, 1080P, and greater), video games, three-dimensional (“3D”) modeling applications, and the like. In some configurations, the processor 602 is configured to communicate with a discrete GPU (not shown). In any case, the CPU and GPU may be configured in accordance with a co-processing CPU/GPU computing model, wherein the sequential part of an application executes on the CPU and the computationally-intensive part is accelerated by the GPU.

In some configurations, the processor 602 is, or is included in, a system-on-chip (“SoC”) along with one or more of the other components described herein below. For example, the SoC may include the processor 602, a GPU, one or more of the network connectivity components 606, and one or more of the sensor components 608. In some configurations, the processor 602 is fabricated, in part, utilizing a package-on-package (“PoP”) integrated circuit packaging technique. Moreover, the processor 602 may be a single core or multi-core processor.

The processor 602 may be created in accordance with an ARM architecture, available for license from ARM HOLDINGS of Cambridge, United Kingdom. Alternatively, the processor 602 may be created in accordance with an x86 architecture, such as is available from INTEL CORPORATION of Mountain View, Calif. and others. In some configurations, the processor 602 is a SNAPDRAGON SoC, available from QUALCOMM of San Diego, Calif., a TEGRA SoC, available from NVIDIA of Santa Clara, Calif., a HUMMINGBIRD SoC, available from SAMSUNG of Seoul, South Korea, an Open Multimedia Application Platform (“OMAP”) SoC, available from TEXAS INSTRUMENTS of Dallas, Tex., a customized version of any of the above SoCs, or a proprietary SoC.

The memory components 604 include a random access memory (“RAM”) 614, a read-only memory (“ROM”) 616, an integrated storage memory (“integrated storage”) 618, and a removable storage memory (“removable storage”) 620. In some configurations, the RAM 614 or a portion thereof, the ROM 616 or a portion thereof, and/or some combination the RAM 614 and the ROM 616 is integrated in the processor 602. In some configurations, the ROM 616 is configured to store a firmware, an operating system or a portion thereof (e.g., operating system kernel), and/or a bootloader to load an operating system kernel from the integrated storage 618 or the removable storage 620.

The integrated storage 618 can include a solid-state memory, a hard disk, or a combination of solid-state memory and a hard disk. The integrated storage 618 may be soldered or otherwise connected to a logic board upon which the processor 602 and other components described herein also may be connected. As such, the integrated storage 618 is integrated in the computing device. The integrated storage 618 is configured to store an operating system or portions thereof, application programs, data, and other software components described herein.

The removable storage 620 can include a solid-state memory, a hard disk, or a combination of solid-state memory and a hard disk. In some configurations, the removable storage 620 is provided in lieu of the integrated storage 618. In other configurations, the removable storage 620 is provided as additional optional storage. In some configurations, the removable storage 620 is logically combined with the integrated storage 618 such that the total available storage is made available and shown to a user as a total combined capacity of the integrated storage 618 and the removable storage 620.

The removable storage 620 is configured to be inserted into a removable storage memory slot (not shown) or other mechanism by which the removable storage 620 is inserted and secured to facilitate a connection over which the removable storage 620 can communicate with other components of the computing device, such as the processor 602. The removable storage 620 may be embodied in various memory card formats including, but not limited to, PC card, CompactFlash card, memory stick, secure digital (“SD”), miniSD, microSD, universal integrated circuit card (“UICC”) (e.g., a subscriber identity module (“SIM”) or universal SIM (“USIM”)), a proprietary format, or the like.

It can be understood that one or more of the memory components 604 can store an operating system. According to various configurations, the operating system includes, but is not limited to, SYMBIAN OS from SYMBIAN LIMITED, WINDOWS MOBILE OS from Microsoft Corporation of Redmond, Wash., WINDOWS PHONE OS from Microsoft Corporation, WINDOWS from Microsoft Corporation, PALM WEBOS from Hewlett-Packard Company of Palo Alto, Calif., BLACKBERRY OS from Research In Motion Limited of Waterloo, Ontario, Canada, IOS from Apple Inc. of Cupertino, Calif., and ANDROID OS from Google Inc. of Mountain View, Calif. Other operating systems are contemplated.

The network connectivity components 606 include a wireless wide area network component (“WWAN component”) 622, a wireless local area network component (“WLAN component”) 624, and a wireless personal area network component (“WPAN component”) 626. The network connectivity components 606 facilitate communications to and from a network 114, which may be a WWAN, a WLAN, or a WPAN. Although a single network 114 is illustrated, the network connectivity components 606 may facilitate simultaneous communication with multiple networks. For example, the network connectivity components 606 may facilitate simultaneous communications with multiple networks via one or more of a WWAN, a WLAN, or a WPAN.

The network 114 may be a WWAN, such as a mobile telecommunications network utilizing one or more mobile telecommunications technologies to provide voice and/or data services to a computing device utilizing the computing device architecture 600 via the WWAN component 622. The mobile telecommunications technologies can include, but are not limited to, Global System for Mobile communications (“GSM”), Code Division Multiple Access (“CDMA”) ONE, CDMA2000, Universal Mobile Telecommunications System (“UMTS”), Long Term Evolution (“LTE”), and Worldwide Interoperability for Microwave Access (“WiMAX”). Moreover, the network 114 may utilize various channel access methods (which may or may not be used by the aforementioned standards) including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Space Division Multiple Access (“SDMA”), and the like. Data communications may be provided using General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, and various other current and future wireless data access standards. The network 114 may be configured to provide voice and/or data communications with any combination of the above technologies. The network 114 may be configured to or adapted to provide voice and/or data communications in accordance with future generation technologies.

In some configurations, the WWAN component 622 is configured to provide dual-multi-mode connectivity to the network 114. For example, the WWAN component 622 may be configured to provide connectivity to the network 114, wherein the network 114 provides service via GSM and UMTS technologies, or via some other combination of technologies. Alternatively, multiple WWAN components 622 may be utilized to perform such functionality, and/or provide additional functionality to support other non-compatible technologies (i.e., incapable of being supported by a single WWAN component). The WWAN component 622 may facilitate similar connectivity to multiple networks (e.g., a UMTS network and an LTE network).

The network 114 may be a WLAN operating in accordance with one or more Institute of Electrical and Electronic Engineers (“IEEE”) 802.11 standards, such as IEEE 802.11a, 802.11b, 802.11g, 802.11n, and/or future 802.11 standard (referred to herein collectively as WI-FI). Draft 802.11 standards are also contemplated. In some configurations, the WLAN is implemented utilizing one or more wireless WI-FI access points. In some configurations, one or more of the wireless WI-FI access points are another computing device with connectivity to a WWAN that are functioning as a WI-FI hotspot. The WLAN component 624 is configured to connect to the network 114 via the WI-FI access points. Such connections may be secured via various encryption technologies including, but not limited, WI-FI Protected Access (“WPA”), WPA2, Wired Equivalent Privacy (“WEP”), and the like.

The network 114 may be a WPAN operating in accordance with Infrared Data Association (“IrDA”), BLUETOOTH, wireless Universal Serial Bus (“USB”), Z-Wave, ZIGBEE, or some other short-range wireless technology. In some configurations, the WPAN component 626 is configured to facilitate communications with other devices, such as peripherals, computers, or other computing devices via the WPAN.

The sensor components 608 include a magnetometer 630, an ambient light sensor 632, a proximity sensor 634, an accelerometer 636, a gyroscope 638, and a Global Positioning System sensor (“GPS sensor”) 640. It is contemplated that other sensors, such as, but not limited to, temperature sensors or shock detection sensors, also may be incorporated in the computing device architecture 600.

The magnetometer 630 is configured to measure the strength and direction of a magnetic field. In some configurations the magnetometer 630 provides measurements to a compass application program stored within one of the memory components 604 in order to provide a user with accurate directions in a frame of reference including the cardinal directions, north, south, east, and west. Similar measurements may be provided to a navigation application program that includes a compass component. Other uses of measurements obtained by the magnetometer 630 are contemplated.

The ambient light sensor 632 is configured to measure ambient light. In some configurations, the ambient light sensor 632 provides measurements to an application program stored within one the memory components 604 in order to automatically adjust the brightness of a display (described below) to compensate for low-light and high-light environments. Other uses of measurements obtained by the ambient light sensor 632 are contemplated.

The proximity sensor 634 is configured to detect the presence of an object or thing in proximity to the computing device without direct contact. In some configurations, the proximity sensor 634 detects the presence of a user's body (e.g., the user's face) and provides this information to an application program stored within one of the memory components 604 that utilizes the proximity information to enable or disable some functionality of the computing device. For example, a telephone application program may automatically disable a touchscreen (described below) in response to receiving the proximity information so that the user's face does not inadvertently end a call or enable/disable other functionality within the telephone application program during the call. Other uses of proximity as detected by the proximity sensor 634 are contemplated.

The accelerometer 636 is configured to measure proper acceleration. In some configurations, output from the accelerometer 636 is used by an application program as an input mechanism to control some functionality of the application program. For example, the application program may be a video game in which a character, a portion thereof, or an object is moved or otherwise manipulated in response to input received via the accelerometer 636. In some configurations, output from the accelerometer 636 is provided to an application program for use in switching between landscape and portrait modes, calculating coordinate acceleration, or detecting a fall. Other uses of the accelerometer 636 are contemplated.

The gyroscope 638 is configured to measure and maintain orientation. In some configurations, output from the gyroscope 638 is used by an application program as an input mechanism to control some functionality of the application program. For example, the gyroscope 638 can be used for accurate recognition of movement within a 3D environment of a video game application or some other application. In some configurations, an application program utilizes output from the gyroscope 638 and the accelerometer 636 to enhance control of some functionality of the application program. Other uses of the gyroscope 638 are contemplated.

The GPS sensor 640 is configured to receive signals from GPS satellites for use in calculating a location. The location calculated by the GPS sensor 640 may be used by any application program that requires or benefits from location information. For example, the location calculated by the GPS sensor 640 may be used with a navigation application program to provide directions from the location to a destination or directions from the destination to the location. Moreover, the GPS sensor 640 may be used to provide location information to an external location-based service, such as E911 service. The GPS sensor 640 may obtain location information generated via WI-FI, WIMAX, and/or cellular triangulation techniques utilizing one or more of the network connectivity components 606 to aid the GPS sensor 640 in obtaining a location fix. The GPS sensor 640 may also be used in Assisted GPS (“A-GPS”) systems.

The I/O components 610 include a display 642, a touchscreen 644, a data I/O interface component (“data I/O”) 646, an audio I/O interface component (“audio I/O”) 648, a video I/O interface component (“video I/O”) 650, and a camera 652. In some configurations, the display 642 and the touchscreen 644 are combined. In some configurations two or more of the data I/O component 646, the audio I/O component 648, and the video I/O component 650 are combined. The I/O components 610 may include discrete processors configured to support the various interface described below, or may include processing functionality built-in to the processor 602.

The display 642 is an output device configured to present information in a visual form. In particular, the display 642 may present graphical user interface (“GUI”) elements, text, images, video, notifications, virtual buttons, virtual keyboards, messaging data, Internet content, device status, time, date, calendar data, preferences, map information, location information, and any other information that is capable of being presented in a visual form. In some configurations, the display 642 is a liquid crystal display (“LCD”) utilizing any active or passive matrix technology and any backlighting technology (if used). In some configurations, the display 642 is an organic light emitting diode (“OLED”) display. Other display types are contemplated.

The touchscreen 644 is an input device configured to detect the presence and location of a touch. The touchscreen 644 may be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or may utilize any other touchscreen technology. In some configurations, the touchscreen 644 is incorporated on top of the display 642 as a transparent layer to enable a user to use one or more touches to interact with objects or other information presented on the display 642. In other configurations, the touchscreen 644 is a touch pad incorporated on a surface of the computing device that does not include the display 642. For example, the computing device may have a touchscreen incorporated on top of the display 642 and a touch pad on a surface opposite the display 642.

In some configurations, the touchscreen 644 is a single-touch touchscreen. In other configurations, the touchscreen 644 is a multi-touch touchscreen. In some configurations, the touchscreen 644 is configured to detect discrete touches, single touch gestures, and/or multi-touch gestures. These are collectively referred to herein as gestures for convenience. Several gestures will now be described. It should be understood that these gestures are illustrative and are not intended to limit the scope of the appended claims. Moreover, the described gestures, additional gestures, and/or alternative gestures may be implemented in software for use with the touchscreen 644. As such, a developer may create gestures that are specific to a particular application program.

In some configurations, the touchscreen 644 supports a tap gesture in which a user taps the touchscreen 644 once on an item presented on the display 642. The tap gesture may be used for various reasons including, but not limited to, opening or launching whatever the user taps. In some configurations, the touchscreen 644 supports a double tap gesture in which a user taps the touchscreen 644 twice on an item presented on the display 642. The double tap gesture may be used for various reasons including, but not limited to, zooming in or zooming out in stages. In some configurations, the touchscreen 644 supports a tap and hold gesture in which a user taps the touchscreen 644 and maintains contact for at least a pre-defined time. The tap and hold gesture may be used for various reasons including, but not limited to, opening a context-specific menu.

In some configurations, the touchscreen 644 supports a pan gesture in which a user places a finger on the touchscreen 644 and maintains contact with the touchscreen 644 while moving the finger on the touchscreen 644. The pan gesture may be used for various reasons. Multiple finger pan gestures are also contemplated. In some configurations, the touchscreen 644 supports a flick gesture in which a user swipes a finger in the direction the user wants the screen to move. The flick gesture may be used for various reasons including, but not limited to, scrolling horizontally or vertically through menus or pages. In some configurations, the touchscreen 644 supports a pinch and stretch gesture in which a user makes a pinching motion with two fingers (e.g., thumb and forefinger) on the touchscreen 644 or moves the two fingers apart. The pinch and stretch gesture may be used for various reasons including, but not limited to, zooming gradually in or out of a website, map, or picture.

Although the above gestures have been described with reference to the use one or more fingers for performing the gestures, other appendages such as toes or objects such as styluses may be used to interact with the touchscreen 644. As such, the above gestures should be understood as being illustrative and should not be construed as being limiting in any way.

The data I/O interface component 646 is configured to facilitate input of data to the computing device and output of data from the computing device. In some configurations, the data I/O interface component 646 includes a connector configured to provide wired connectivity between the computing device and a computer system, for example, for synchronization operation purposes. The connector may be a proprietary connector or a standardized connector such as USB, micro-USB, mini-USB, or the like. In some configurations, the connector is a dock connector for docking the computing device with another device such as a docking station, audio device (e.g., a digital music player), or video device.

The audio I/O interface component 648 is configured to provide audio input and/or output capabilities to the computing device. In some configurations, the audio I/O interface component 646 includes a microphone configured to collect audio signals. In some configurations, the audio I/O interface component 646 includes a headphone jack configured to provide connectivity for headphones or other external speakers. In some configurations, the audio interface component 648 includes a speaker for the output of audio signals. In some configurations, the audio I/O interface component 646 includes an optical audio cable out.

The video I/O interface component 650 is configured to provide video input and/or output capabilities to the computing device. In some configurations, the video I/O interface component 650 includes a video connector configured to receive video as input from another device (e.g., a video media player such as a DVD or BLURAY player) or send video as output to another device (e.g., a monitor, a television, or some other external display). In some configurations, the video I/O interface component 650 includes a High-Definition Multimedia Interface (“HDMI”), mini-HDMI, micro-HDMI, DisplayPort, or proprietary connector to input/output video content. In some configurations, the video I/O interface component 650 or portions thereof is combined with the audio I/O interface component 648 or portions thereof.

The camera 652 can be configured to capture still images and/or video. The camera 652 may utilize a charge coupled device (“CCD”) or a complementary metal oxide semiconductor (“CMOS”) image sensor to capture images. In some configurations, the camera 652 includes a flash to aid in taking pictures in low-light environments. Settings for the camera 652 may be implemented as hardware or software buttons.

Although not illustrated, one or more hardware buttons may also be included in the computing device architecture 600. The hardware buttons may be used for controlling some operational aspect of the computing device. The hardware buttons may be dedicated buttons or multi-use buttons. The hardware buttons may be mechanical or sensor-based.

The illustrated power components 612 include one or more batteries 654, which can be connected to a battery gauge 656. The batteries 654 may be rechargeable or disposable. Rechargeable battery types include, but are not limited to, lithium polymer, lithium ion, nickel cadmium, and nickel metal hydride. Each of the batteries 654 may be made of one or more cells.

The battery gauge 656 can be configured to measure battery parameters such as current, voltage, and temperature. In some configurations, the battery gauge 656 is configured to measure the effect of a battery's discharge rate, temperature, age and other factors to predict remaining life within a certain percentage of error. In some configurations, the battery gauge 656 provides measurements to an application program that is configured to utilize the measurements to present useful power management data to a user. Power management data may include one or more of a percentage of battery used, a percentage of battery remaining, a battery condition, a remaining time, a remaining capacity (e.g., in watt hours), a current draw, and a voltage.

The power components 612 may also include a power connector, which may be combined with one or more of the aforementioned I/O components 610. The power components 612 may interface with an external power system or charging equipment via a power I/O component.

Based on the foregoing, it should be appreciated that technologies for monitoring a service using interaction zones have been disclosed herein. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example configurations and applications illustrated and described, and without departing from the true spirit and scope of the present invention, which is set forth in the following claims.

What is claimed is:

1. A computer-implemented method comprising performing computer-implemented operations for:
receiving an input of one or more interaction zones;
receiving an input of one or more processes within a service; and
associating at least one of the one or more processes with at least one of the one or more interaction zones.

2. The computer-implemented method of claim 1, further comprising receiving an identity of a tool to be used in at least one of the one or more processes.

3. The computer-implemented method of claim 2, further comprising associating the identity of the tool with at least one of the one or more processes.

4. The computer-implemented method of claim 3, further comprising updating a status of the service based on a location of the tool with respect to the one or more interaction zones.

5. The computer-implemented method of claim 4, where the status of the service comprises a valid condition or an invalid condition.

6. The computer-implemented method of claim 1, further comprising receiving an identity of a service provider to be used in at least one of the one or more processes.

7. The computer-implemented method of claim 6, further comprising associating the identity of the service provider with at least one of the one or more processes.

8. The computer-implemented method of claim 7, further comprising updating a status of the service based on a location of the service provider with respect to the one or more interaction zones.

9. The computer-implemented method of claim 8, where the status of the service comprises a valid condition or an invalid service provider.

10. A computer-readable storage medium having computer readable instructions stored thereupon that, when executed by a computer, cause the computer to:
receive an input of one or more interaction zones associated with a service, the service comprising one or more processes;
associate one or more processes with at least one of the one or more interaction zones;
receive an identity of a tool to be used in at least one of the one or more processes;
receive an identity of a service provider to be used in at least one of the one or more processes; and
update a process of the service based on a location of the tool or the service provider within the one or more interaction zones.

11. The computer-readable storage medium of claim 10, wherein a valid condition occurs when the tool is proximate to the service provider when the service provider is within a designated interaction zone of the one or more interaction zones and an invalid condition occurs when the service provider is not within the designated interaction zone of the one or more interaction zones.

12. The computer-readable storage medium of claim 10, wherein the identity of the tool comprises a stored condition, an in-transport condition, an in-use condition, or a used condition.

13. The computer-readable storage medium of claim 10, wherein at least one process of the one or more processes comprises an invalid condition if an incorrect tool is located within a designated interaction zone during the at least one process.

14. The computer-readable storage medium of claim 10, wherein at least one process of the one or more processes comprises an invalid condition if a correct tool and an incorrect service provider are located within a designated interaction zone during the at least one process.

15. A system comprising:
a location determination apparatus; and
a computing system comprising
a processor; and
a computer-readable storage medium in communication with the processor, the computer-readable storage medium having computer-executable instructions stored thereupon which, when executed by the processor, cause the processor to
receive an input of one or more interaction zones associated with a service, the service comprising one or more processes;
associate one or more processes with at least one of the one or more interaction zones;
receive an identity of a tool to be used in at least one of the one or more processes;
receive an identity of a service provider to be used in at least one of the one or more processes; and
update a process of the service based on a location, provided by the location determination apparatus, of the tool or the service provider within the one or more interaction zones.

16. The system of claim 15, wherein at least one process of the one or more processes comprises an invalid condition if an incorrect tool is located within a designated interaction zone during the at least one process.

17. The system of claim 15, wherein at least one process of the one or more processes comprises an invalid condition if a correct tool and an incorrect service provider are located within a designated interaction zone during the at least one process.

18. The system of claim 15, wherein the location determination apparatus comprises an infrared light transmitter, an infrared light receiver, and a computing apparatus configured to determine a location based on infrared light transmitted by the infrared light transmitter and received at the infrared light receiver.

19. The system of claim 15, wherein the location determination apparatus comprises a global positioning system.

20. The system of claim 15, wherein the location determination apparatus comprises a radio frequency tag system.

21. The system of claim 15, wherein the interaction zones are time-based.

22. The system of claim 15, wherein the location is determined using an automatic identification and data capture device.
